(19) United States
(12) Patent Application Publication
(10) Pub. No.: US 2013/0043411 A1
(43) Pub. Date: Feb. 21, 2013

(54) METHOD AND APPARATUS FOR TREATING MAGNETIC RECORDING MEDIUM WITH ULTRAVIOLET RADIATION

(71) Applicants: Takako MATSUMOTO, Matsumoto-city (JP); Kenji Hishinuma, Hino-city (JP); Yoshinori Ozawa, Nagano (JP)

(72) Inventors: Takako MATSUMOTO, Matsumoto-city (JP); Kenji Hishinuma, Hino-city (JP); Yoshinori Ozawa, Nagano (JP)

(73) Assignee: FUJI ELECTRIC CO., LTD., Kawasaki-shi (JP)

(21) Appl. No.: 13/584,620

(22) Filed: Aug. 13, 2012

(30) Foreign Application Priority Data
Aug. 16, 2011 (JP) 2011-177925

(51) Int. Cl. B01J 19/12

(52) U.S. Cl. 250/492.1

(57) ABSTRACT

A method and apparatus for treating a magnetic recording medium having a magnetic film, a protective film, and a lubricant film on a non-magnetic substrate, with UV radiation. The method includes holding the medium with a resin while irradiating the medium with UV radiation. The apparatus includes a UV irradiation part for irradiating the medium by a UV lamp and a holding part made of resin.

### CROSS-REFERENCE TO RELATED APPLICATION

This application claims the benefit of priority of Japanese patent application number 2011-177925, filed on Aug. 16, 2011, the disclosure of which is incorporated herein by reference.

### BACKGROUND OF THE INVENTION

1. Field of the Invention

The present invention relates to a method and apparatus for treating a magnetic recording medium with ultraviolet radiation. Particularly, the present invention relates to a method and apparatus for treating a magnetic recording medium used in, for example, an external storage device or the like of a computer by using ultraviolet radiation.

2. Description of the Related Art

Lubricants for use in magnetic recording media, particularly in magnetic disks, have been developed in order to improve the durability and reliability of a magnetic recording medium by reducing a frictional force generated between a protective film of the magnetic recording medium and a head.

For example, attempts have conventionally been made to improve the lubrication characteristics of the surface layer of a magnetic disk: forming a diamond-like carbon (DLC) protective film on the surface layer and then forming on this protective film a perfluoropolyether lubricant film having a polar end group, such as a hydroxyl group, or a cyclic triphosphazene end group.

The lubricant film on the protective film consists of two layers: a layer bound to the protective layer (referred to as “bonded lubricant layer,” hereinafter), and a layer not bound to the protective layer (referred to as “free lubricant layer,” hereinafter). It is appropriate, from the perspective of the improvement of the lubrication characteristics, that the lubricant film has a thin free lubricant layer and a thick bonded lubricant layer.

However, with the recent growth in density of the magnetic disks, demands for the lubrication characteristics are becoming more and more difficult. In the future, therefore, it is inevitable to increase the maximum film thickness of the bonded lubricant layer.

Moreover, the recent hard disk drives are becoming more and more versatile, ranging from personal computers used indoors, to portable devices and car navigation systems used outdoors. Especially in an environment with high temperature and high humidity where the moisture contained in the highly humid air adheres to the disks of a hard disk drive, the moisture inhibits the magnetic head slider from floating above the disks. The problem, therefore, is how to form the lubricant film on the surface of each magnetic disk more precisely.

Increasing the film thickness of the bonded lubricant layer has been proposed as a method for solving the problem described above. In order to increase the film thickness of the bonded lubricant layer, it is said to be effective to treat each magnetic disk using ultraviolet radiation during the formation of the bonded lubricant layer. When treating each magnetic disk with ultraviolet radiation, magnetic disks are held one by one, carried into a UV house for treating the magnetic disks with ultraviolet radiation. The magnetic disks are each oscillated vertically in the UV house and evenly irradiated with the ultraviolet radiation.

Unfortunately, vertically oscillating each magnetic disk in the UV house can damage the outer periphery of the magnetic disk as a result of a contact between the magnetic disk and parts (claws) holding the magnetic disk. Moreover, with the increase in recording capacity, a wider area of a magnetic disk, particularly including the outer periphery of the magnetic disk, needs to have more stable flying capability. In addition, improvements need to be urgently made regarding the damages which degrade the flying capability around the outer periphery. In the conventional holding parts for holding magnetic disks in UV treatments, metal was used as the material of the holding parts in order to prevent discoloration and deformation of the disks in long-term UV radiation. In recent years, however, high-output lamps have been used in order to reduce the UV radiation time and increase the efficiency of the UV radiation. Therefore, it is difficult to use materials other than metal in the holding parts.

### SUMMARY OF THE INVENTION

The present invention was contrived in view of the problems described above, and an object thereof is to prevent the outer periphery of a magnetic recording medium from being damaged when treating the magnetic recording medium with ultraviolet radiation.

In some embodiments of the invention, a method for treating a magnetic recording medium with UV radiation is provided. The medium includes a magnetic film, a protective film, and a lubricant film on a non-magnetic substrate. The method includes holding the magnetic recording medium with a resin. The method further includes concurrently with said holding, irradiating the magnetic recording medium with the UV radiation.

In some embodiments of the invention, an apparatus for treating a magnetic recording medium with UV radiation is provided. The medium includes a magnetic film, a protective film, and a lubricant film on a non-magnetic substrate. The apparatus includes a UV irradiation part for irradiating the medium by a UV lamp. The apparatus further includes a holding part that holds the medium. The holding part is formed of resin.

It is preferred that the resin be Vespel.

The present invention is capable of preparing a magnetic recording medium, the outer periphery of which is prevented from being damaged, and provides a magnetic recording medium which, including the outer periphery thereof, can have stable flying capability.

### BRIEF DESCRIPTION OF THE DRAWINGS

FIG. 1 is a schematic diagram showing a magnetic recording medium suitably used in the present invention, and a holding part for holding the magnetic recording medium when the magnetic recording medium is treated with ultraviolet radiation;

FIG. 2 shows the results of OSA measurement obtained when the magnetic recording medium is treated with ultraviolet radiation using a metallic claw; and

FIG. 3 shows the results of OSA measurement obtained when the magnetic recording medium is treated with ultraviolet radiation using a resin claw.

FIG. 4 shows a side view of the magnetic recording medium and the holding part illustrated in FIG. 1.

FIG. 5 shows an embodiment of the holding claw.

FIG. 6 shows an embodiment of the holding claw.

FIG. 7 shows an embodiment of the holding claw.

### DESCRIPTION OF THE PREFERRED EMBODIMENTS

The method for treating a magnetic recording medium with ultraviolet radiation is a method for using ultraviolet radiation to treat a magnetic recording medium having a magnetic film, a protective film, and a lubricant film on a non-magnetic substrate. An ordinary non-magnetic substrate, magnetic film, and protective film can be used as the non-magnetic substrate, the protective film, and the protective film.

The method according to the present invention includes a UV irradiation step of irradiating a magnetic recording medium with a UV lamp, and the UV irradiation step is carried out while holding the magnetic recording medium with resin. According to the example described hereinafter, the entire holding part is made of resin; however, a part of the holding part may be configured as a claw, and only the claw may be made of resin. It is preferred that the thickness of the resin be 2 mm or more in order to appropriately hold the magnetic recording medium.

the resin is preferably Vespel®. Examples of other preferred resins include PEEK and polyamide-imide resin.

A preferred lubricant used in the present invention includes a perfluoropolyether main chain, as shown in the following chemical formulas I and 2, wherein at least one of the ends R₁, R₂, and R₃ has a plurality of functional groups and a molecular weight of 500 to 10,000.

R₁—(CF₂CF₂O)ₚ—(CF₂O)_{q}—R₂ [C 1]

(where p and q are positive integers)

F—(CF₂CF₂CF₂O)ᵣ—R₃ [C 2]

(where r is a positive integer)

In the end structures illustrated above, it is preferred that each functional group be selected from any one of or more than one of the following: hydroxyl group, carboxyl group, aldehyde group, primary and secondary amine groups, nitro group, nitrile group, isonitrile group, isocyanato group, thiol group, sulfo group, and heterocycle. An additive may be added to the lubricant, in which case, as well, the effects of the present invention can be achieved.

FIG. 1 is a schematic diagram showing examples of a magnetic disk 10 and holding part 12 used suitably in the present invention. The magnetic disk 10 is held by a claw 12a of a holding part 12 of an apparatus (not shown).

In order to prevent the magnetic recording medium from being damaged when the outer periphery thereof comes into contact with the holding part 12, resin is used in the holding part 12 so that the outer periphery of the magnetic recording medium 10 is not damaged when coming into contact with the holding part during the UV treatment. Particularly, with the heat resistance property and wear resistance property of Vespel, the outer periphery of the magnetic recording medium 10 can be prevented more effectively from being damaged when coming into contact with the holding part 12 during the UV treatment.

### Example

An example of the present invention is described hereinafter. The example merely illustrates a typical example of the present invention; thus, the present invention should not be limited to the illustration of the example.

A mixture of Z-Tetraol (produced by Solvay Solexis) having a —OH end group and ADOH (produced by MORESCO Corporation) was used as the lubricant. The percentage of the ADOH in the mixture was 37.5%. Using a metal claw of a conventional holding part and a resin claw of the present invention (the claw made of Vespel in the following example) in UV treatment, damages on the outer peripheries of magnetic disks were compared with each other by means of an OSA (optical surface analyzer).

[Application of Lubricant to Magnetic Recording Medium, and Evaluation of Properties of Lubricant]

1. Sample Preparation—Application of Lubricant

An amorphous carbon protective film having a film thickness of 2.0 nm was formed according to a plasma CVD method and applied to a 65-mm diameter magnetic disk substrate and a 95-mm diameter magnetic disk substrate. These magnetic disk substrates were applied with the abovementioned lubricant mixture by a dip method. Specifically, each magnetic disk substrate was soaked in the lubricant mixture having Vertrel XF (produced by Du-Pont Mitsui Fluorochemicals) as a solvent for 72 seconds, pulled out of the mixture at 1.5 mm/sec, and then dried, to create a magnetic disk. After the lubricant mixture was applied to the magnetic disk sample, the magnetic disk was treated with the ultraviolet radiation for 8 seconds by a 200 W UV lamp with a wavelength of 185 nm/254 nm.

The film thickness of the lubricant layer of the sample prepared in the manner described above was measured by a Fourier transform infrared spectrophotometer (FT-IR). The magnetic disk sample was prepared such that the targeted film thickness of the lubricant layer is based on the followings: the total film thickness is 8.00 Å, the film thickness of the bonded lubricant layer is 6.00 Å, and the bonded ratio is 75.0%.

The abovementioned terms “total film thickness,” “film thickness of the bonded lubricant layer,” and “bonded ratio” are described below.

The bonded ratio between the functional groups existing on the carbon surface and the lubricant is generally represented as a ratio of the film thickness of the lubricant layer rinsed with a fluorinated solvent to the film thickness of the lubricant layer obtained before being rinsed with the fluorinated solvent. The percentage of it is called “bonded ratio.”

Bonded ratio (%)=Film thickness of lubricant layer after rinsing/Film thickness of lubricant layer before rinsing×100 [E 1]

The film thickness of the lubricant layer before rinsing is referred to as “total film thickness,” and the film thickness of the lubricant layer after rinsing is referred to as “film thickness of the bonded lubricant layer.” The “film thickness of the bonded lubricant layer” represents the film thickness (amount) of the lubricant layer actually bound to the carbon surface.

Vertrel XF (produced by Du-Pont Mitsui Fluorochemicals) is generally used as the fluorinated solvent. Therefore, this solvent was used in this evaluation.

2. Preparation of Claw of Holding Part

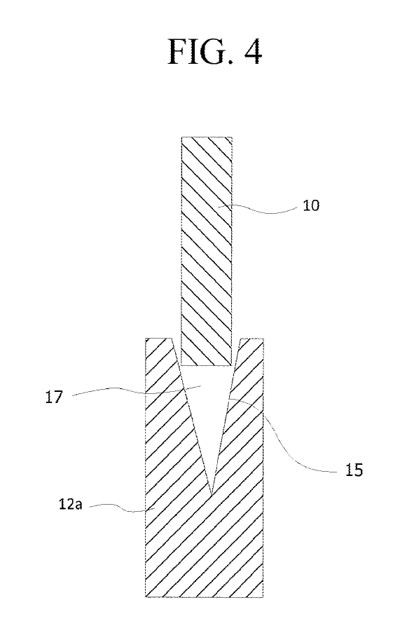

In this experiment, the holding part 12 has the shape shown in FIG. 1 and in FIG. 4 which is a side view of FIG. 1. The holding part 12 was used to hold the magnetic disk 10 (a typical example of the magnetic recording medium), and the magnetic disk 10 was treated with ultraviolet radiation. The claw 12a of the holding part 12 is in the shape of “Y” that is formed by 45-degree inclined surfaces 15 that are formed in the depth direction of the grooves 17 to make minimum points of contact with the magnetic disk 10. The claw 12a can hold the edge of the magnetic disk 10 such that the magnetic disk 10 stands perpendicularly (i.e., vertically) in the grooves. The claw 12a is made of Vespel through molding, cutting, and polishing steps.

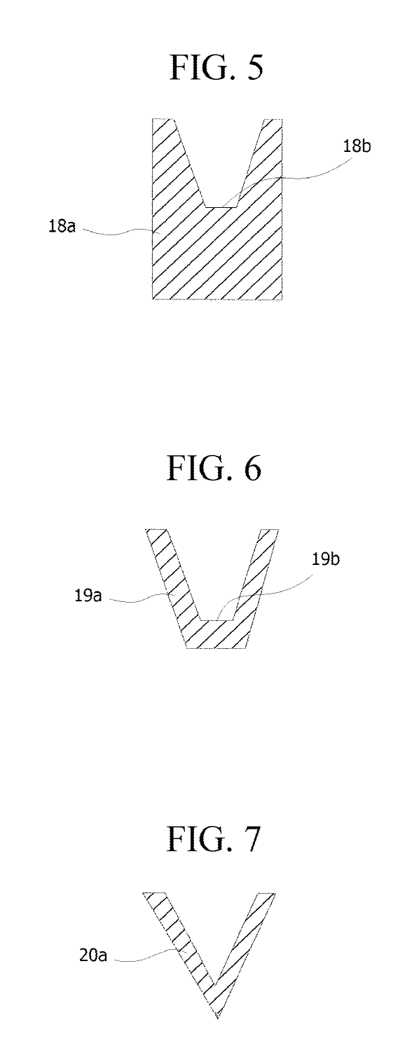

FIGS. 5-7 all show embodiments of the claw 12a. Details that are similar to those shown in FIGS. 1 and 4 will be omitted when discussing FIGS. 5-7. In FIG. 5, the claw 18a has a flat bottom 18b. This allows an outer periphery of the magnetic disk 10 to sit in the flat bottom 18b and thereby be supported.

FIG. 6 illustrates a claw 19a having a flat bottom 19b to engage the outer periphery of the magnetic disk 10. The claw 19a is thinner than the claw 18a, and therefore the quantity of material used in the claw 19a is less than that in claw 18a.

FIG. 7 illustrates a V-shaped claw 20a. The claw 20a is thinner than the claw 12a illustrated in FIGS. 1 and 4, and therefore uses less material.

3. Evaluation of Damages on Outer Periphery

The magnetic disk sample prepared in the process described above was subjected to OSA measurement with different claws by using OSA 6100 produced by Candela.

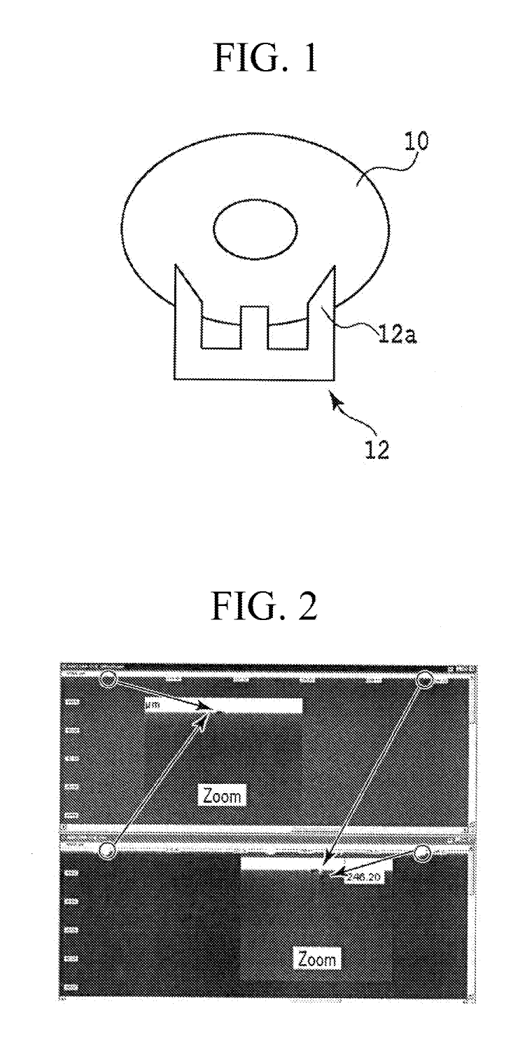

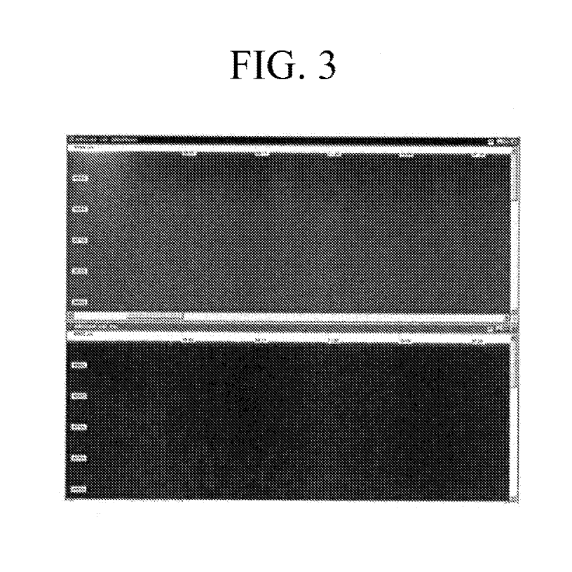

FIGS. 2 and 3 show OSA image data that resulted from treating the 95-mm diameter magnetic disk with ulraviolet radiation, the magnetic disk having a thickness of 1.75 mm. FIG. 2 shows the data obtained by treating the magnetic disk using the conventional metallic claw, and FIG. 3 shows the data obtained by treating the magnetic disk using the resin (Vespel) claw of the present invention.

In a Q-phase mode of each OSA image (a mode where P-waves and S-waves are synthesized, the mode being generally used for observing a lubricant), the parts where the lubricant film becomes thin appear white. In a Psc mode (a mode where the reflections of P-waves are used to observe damages and particles on the surface), the parts with damages and particles appear to reflect as white.

In FIG. 2, the upper picture shows the data obtained in the Q-phase mode, and the lower picture shows the data obtained in the Psc mode. The parts that appear to be different from the surrounding parts in the Q-phase mode overlap with the parts that appear white in the Psc mode. This indicates that the parts in contact with the claw are damaged, and that approximately the same degree of damage occur in the outer peripheries of all eight surfaces out of eight surfaces.

In FIG. 3, the upper picture shows the data obtained in the Q-phase mode, and the lower picture shows the data obtained in the Psc mode. In both the Q-phase mode and the Psc mode, the parts in contact with the claw are hardly visible. This indicates that the outer peripheries are not damaged, meaning that none of the eight surfaces is damaged.

According to these results, changing the material of the claw used in the UV treatment to the resin can effectively reduce the occurrence of damage to the outer peripheries. Especially Vespel that is used as the material of the claw is known to have excellent wear resistance and heat resistance properties. Therefore, Vespel can be used stably even in long-term UV radiation and is more excellent than the metallic claw as the material for reducing damage to the outer periphery of a magnetic recording medium.

Unlike the conventional technology, the present invention is capable of treating a magnetic disk with ultraviolet radiation without damaging the outer periphery thereof, and of producing a magnetic disk, the outer periphery of which is prevented from being damaged.

What has been described above includes examples of embodiments represented by the appended claims. It is, of course, not possible to describe every conceivable combination of components or methodologies encompassed by the claims, but it should be understood that many further combinations and permutations are possible. Accordingly, the claims are intended to embrace all such combinations, permutations, alterations, modifications and variations that fall within the spirit and scope of the claims. Moreover, the above description, and the Abstract, are not intended to be exhaustive or to limit the spirit and scope of the claims to the precise forms disclosed.

What is claimed is:

1. A method for treating a magnetic recording medium with UV radiation, the medium including a magnetic film, a protective film, and a lubricant film on a non-magnetic substrate, the method comprising:
holding the medium with a resin; and
concurrently with said holding, irradiating the magnetic recording medium with the UV radiation.

2. The method according to claim 1, wherein the resin is Vespel.

3. The method according to claim 1, wherein said holding includes holding the medium with a claw made of the resin.

4. The method according to claim 3, wherein the claw is Y-shaped.

5. The method according to claim 4, wherein the claw is formed entirely of the resin.

6. The method according to claim 1, wherein said holding includes holding the medium by a claw made entirely of the resin.

7. An apparatus for treating a magnetic recording medium with UV radiation, the medium including—a magnetic film, a protective film, and a lubricant film on a non-magnetic substrate, the apparatus comprising:
a UV irradiation part for irradiating the medium by a UV lamp; and
a holding part that holds the medium,
wherein the holding part is formed of resin.

8. The apparatus according to claim 7, wherein the resin is Vespel.

9. The apparatus according to claim 7, wherein all of the holding part that holds the medium is formed of the resin.

10. The apparatus according to claim 7, wherein the holding part includes a claw that holds the medium.

11. The apparatus according to claim 10, wherein the claw is Y-shaped.
